(19) United States
(12) Patent Application Publication
(10) Pub. No.: US 2015/0361724 A1
(43) Pub. Date: Dec. 17, 2015

(54) ICE DRILL

(71) Applicant: Clifford Feldmann, St. Cloud, FL (US)

(72) Inventor: Clifford Feldmann, St. Cloud, FL (US)

(21) Appl. No.: 14/580,047

(22) Filed: Dec. 22, 2014

Related U.S. Application Data
(63) Continuation-in-part of application No. 14/318,225, filed on Jun. 27, 2014, now Pat. No. 9,175,639.
Application No. 14/318,225 is a continuation of application No. 14/014,862, filed on Aug. 30, 2013, now Pat. No. 8,777,188.
Application No. 14/014,862 is a continuation-in-part of application No. 12/983,795, filed on Jan. 3, 2011, now abandoned.
(60) Provisional application No. 61/695,226, filed on Aug. 30, 2012.
(60) Provisional application No. 61/291,991, filed on Jan. 4, 2010.

(51) Int. Cl. E21B 7/00; F02M 9/08; F02M 21/02

(52) U.S. Cl. CPC E21B 7/008; F02M 21/0212; F02M 9/08

(57) ABSTRACT

An ice drill. The ice drill includes a power head. The power head is configured to allow the user to control operation of the ice drill. The ice drill also includes an engine. The engine includes a propane carburetor. The propane carburetor includes a plunger valve. The plunger valve includes a body, a set of flutes on the body, and a tip. The ice drill further includes a cutting blade. The cutting blade configured to be moved by the engine to create a hole in ice.

### CROSS-REFERENCE TO RELATED APPLICATIONS

This application is a continuation in part of, and claims the benefit of and priority to, U.S. Non-Provisional patent application Ser. No. 14/318,225 filed on Jun. 27, 2014, which application is incorporated herein by reference in its entirety.

U.S. Non-Provisional patent application Ser. No. 14/318,225 is a continuation of, and claims the benefit of and priority to, U.S. Non-Provisional patent application Ser. No. 14/014,862 filed on Aug. 30, 2013, which application is incorporated herein by reference in its entirety.

U.S. Non-Provisional patent application Ser. No. 14/014,862 claims the benefit of and priority to U.S. Provisional Patent Application Ser. No. 61/695,226 filed on Aug. 30, 2012, which application is incorporated herein by reference in its entirety.

U.S. Non-Provisional patent application Ser. No. 14/014,862 is a continuation-in-part of, and claims the benefit of and priority to, U.S. Non-Provisional patent application Ser. No. 12/983,795 filed on Jan. 3, 2011, which application is incorporated herein by reference in its entirety.

U.S. Non-Provisional patent application Ser. No. 12/983,795 claims the benefit of and priority to U.S. Provisional Patent Application Ser. No. 61/291,991 filed on Jan. 4, 2010, which application is incorporated herein by reference in its entirety.

### BACKGROUND OF THE INVENTION

Gasoline carburetors have been used extensively in internal combustion engines. Small engines and large engines have both been designed with carburetors to provide the fuel and air mixture needed to power the engine. In particular, the engine pulls in a fuel and air mixture from the carburetor where it is combusted, producing mechanical power. The carburetor, in turn, pulls in fuel and air in the correct ratio and mixes them. Small engines, in particular, benefit from the relative simplicity of the carburetor and the mechanical reliability of the carburetor over long periods of time.

Gasoline, as a fuel, however, has a number of drawbacks. For example, gasoline engines, especially small engines, may need to be primed and properly choked to allow the engine to start. Over priming of the engine can flood the engine. Once the engine has been flooded, the operator must generally wait for a period of time for the excess gasoline to evaporate from the combustion chamber before attempting to once again start the engine.

In addition, gasoline does not work well as a fuel at colder temperatures. In particular, in colder applications engines often will not start on their own. Instead the engine must be heated before starting or else the gasoline will not ignite. I.e., the operator must turn on a heater, either electric or using some other fuel source, which heats the engine for a time before turning on the engine. This can lead to unacceptable delays.

Further, gasoline produces a high amount of carbon dioxide emissions. Carbon dioxide is considered by some to be a greenhouse gas, the excess production of which is implicated in global warming. In addition, gasoline can contain a number of other pollutants, such as sulfur, carbon monoxide, nitrogen oxides and hydrocarbons, which can be released into the atmosphere when the gasoline is combusted. The production of these pollutants has become highly regulated by a number of governments because of their adverse environmental effects.

Moreover, gasoline makes for difficult throttle control. That is, slight changes in the throttling of gasoline engines can make for large changes in the power produced in the engine. Additionally, the ratio of gasoline to air is quite sensitive, making precise throttling adjustments with gasoline engines difficult. This is particularly true at lower temperatures. The ratio of gasoline to air needs to be higher at lower temperature and lower at higher at lower temperatures, making the engine difficult to control at times, especially in cold weather applications. This can be especially troublesome when precise engine control is required.

Finally, gasoline which is spilled can contaminate the immediate area. The gasoline can evaporate into the atmosphere where it is a pollutant. Alternatively, the gasoline can foul other equipment. For example, in ice fishing a drill is used to drill through the ice to reach water. If the ice fisherman spills gasoline or gets it on his hands or otherwise spreads it such that the gasoline gets on the fishing equipment, the equipment is fouled and cannot be used until the equipment is cleaned.

There are other fuels available for engines. For example, natural gas, propane and other volatile hydrocarbons are readily available. Because they are gases when not stored under pressure the chances of contamination are much lower. Additionally, engines using volatile hydrocarbons do not need to be primed, as the fuel naturally and quickly diffuses to the combustion chamber. Further, the operating temperature ranges of these fuels are much larger and the throttle control may be much better. However, standard carburetors are poorly suited for propane engines and engines which use other volatile hydrocarbons. The ratio of fuel to air in these engines can vary dramatically from the ratio used in a gasoline engine.

Accordingly, there is a need in the art for a carburetor which works with non-gasoline engines. Further, there is a need in the art for the carburetor to provide accurate throttle control for the engine, even at lower temperatures. In addition, there is a need in the art for a carburetor which works with fuels that are unlikely to contaminate other equipment.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes an ice drill. The ice drill includes a power head. The power head is configured to allow the user to control operation of the ice drill. The ice drill also includes an engine. The engine includes a propane carburetor. The propane carburetor includes a plunger valve. The plunger valve includes a body, a set of flutes on the body, and a tip. The ice drill further includes a cutting blade. The cutting blade configured to be moved by the engine to create a hole in ice.

Another example embodiment includes an ice drill. The ice drill includes a power head. The power head configured to allow the user to control operation of the ice drill. The ice drill also includes an engine. The engine includes a propane carburetor. The propane carburetor includes a plunger valve. The plunger valve includes a body, configured to reduce wedging during operation and eliminate flutter when connected to a diaphragm. The length of the body is between 13 millimeters and 20 millimeters. The plunger valve also includes a set of flutes on the body configured to reduce wedging during operation and eliminate flutter when connected to a diaphragm. The set of flutes are each symmetrically spaced about the axis of the body. The plunger valve further includes a tip. The ice drill further includes a cutting blade, the cutting blade configured to be moved by the engine to create a hole in ice.

Another example embodiment includes an ice drill. The ice drill includes a power head. The power head configured to allow the user to control operation of the ice drill. The ice drill also includes an engine. The engine includes a propane carburetor. The propane carburetor includes an air intake, where the air intake allows air to enter the propane carburetor. The propane carburetor also includes a propane intake. The propane intake allows propane to enter the propane carburetor. The propane intake includes a plunger valve. The plunger valve includes a body, where the length of the body is less than 20 millimeters and a sold lubricant on the body of the plunger valve. The plunger valve also includes a set of flutes on the body configured to reduce wedging during operation and eliminate flutter when connected to a diaphragm, where the set of flutes are each symmetrically spaced about the axis of the body. The plunger valve further includes a tip. The propane carburetor also includes a mixing chamber, where the propane entering the propane carburetor through the propane intake and the air entering the propane carburetor through the air intake are mixed in the mixing chamber. The ice drill further includes a cutting blade, the cutting blade configured to be moved by the engine to create a hole in ice.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of an ice drill;

FIG. 2 illustrates an example of a cutting head;

FIG. 3 illustrates an example of a power head;

FIG. 4 illustrates an example of a reciprocating engine;

FIG. 5A illustrates a side view of a propane carburetor;

FIG. 5B illustrates a perspective view of the propane carburetor;

FIG. 5C illustrates an alternative side view of the propane carburetor;

FIG. 6 illustrates a cut away view of the propane carburetor;

FIG. 7A illustrates a side view of the disk actuator in idle position;

FIG. 7B illustrates a perspective view of the disk actuator in idle position;

FIG. 8A illustrates a side view of the disk actuator at full throttle;

FIG. 8B illustrates a perspective view of the disk actuator at full throttle;

FIG. 9A illustrates a first side of the diaphragm of the carburetor;

FIG. 9B illustrates the opposite side of the diaphragm of the carburetor;

FIG. 10 illustrates the carburetor of FIG. 6 with the diaphragm removed;

FIG. 11 illustrates the carburetor of FIG. 7 with the plunger valve removed;

FIG. 12A illustrates a side view of the plunger valve; and

FIG. 12B illustrates an end view of the plunger valve.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

### I. ICE DRILL

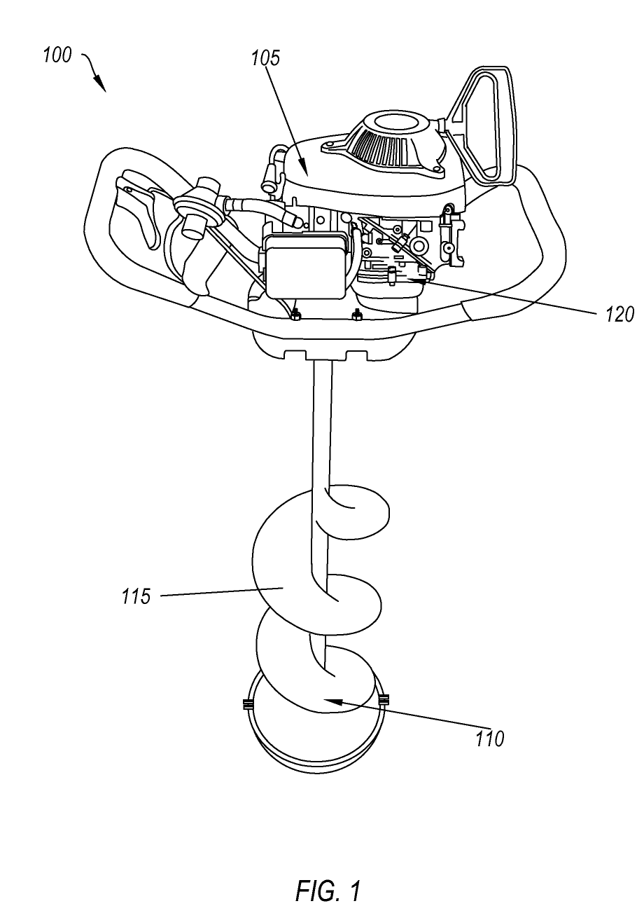

FIG. 1 illustrates an example of an ice drill 100. The ice drill 100 is used to create holes (the size of the hole generally suggested is 8 inches (20 cm)) in ice that covers a lake or other body of water and allows access to the water beneath the ice for fishing or other activities. E.g., the ice drill 100 can be used to create a hole in ice through which an angler can attempt to catch fish.

FIG. 1 shows that the ice drill 100 can include a power head 105. The power head 105 allows a user to control the ice drill 100. In particular, the user holds to the power head 105 to use the ice drill 100 to create the desired hole. For example, the power head 105 can include a throttle, handles, etc. which allow the user to control the placement and operation of the ice drill 100.

FIG. 1 also shows that the ice drill 100 can include a cutting head 110. The cutting head 110 creates the hole in the ice. I.e., the cutting head 110 is the portion of the ice drill 100 which removes ice to create a hole through which fishing or other activities can occur. The cutting head 110 can be modified or exchanged in order to change the hole which will be created or to replace worn out parts.

FIG. 1 additionally shows that the ice drill 100 includes an auger 115. The auger 115 (or “bit”) is a helical screw which lifts the cut ice out of the hole. Typically, the cut ice “climbs” (i.e., is pushed up by cut ice produced by the cutting blade, described below) the auger 115 until it rises above the ice surface, at which point the rotating motion of the auger 115 causes the cut ice to exit the auger 115 where it collects on the surface of the ice.

FIG. 1 moreover shows that the ice drill 100 includes an engine 120. An engine 120 or motor is a machine designed to convert energy into useful mechanical motion. For example, an internal combustion engine burns fuel to produce power. This power is then used by the ice drill 100 to turn the cutting head 110 and the auger 115. Thus, the engine 120 burns propane in order to produce motion of the cutting head 110 and the auger 115 to remove ice, creating a hole in the ice.

### II. CUTTING HEAD

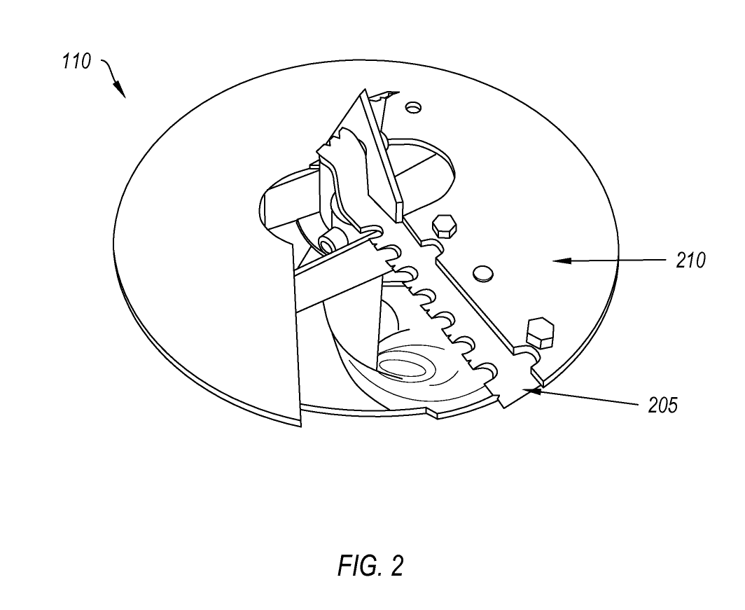

FIG. 2 illustrates an example of a cutting head 110. The cutting head 110 creates the hole in the ice. I.e., the cutting head 110 is the portion of the ice drill which actually removes ice. The cutting head 110, or portion thereof, may be replaced as they become dull or worn out. I.e., the cutting head 110, or portions thereof, may be removed from the ice drill by a user.

FIG. 2 shows that the ice drill can include a cutting blade 205. The cutting blade 205 creates the hole in the ice. In particular, the cutting blade 205 is angled so that as it rotates it digs into the ice and cut ice is removed from the hole that has been created. I.e., with each successive pass the cutting blade 205 passes lower into the ice, creating a new surface which will be removed in future passes.

FIG. 2 also shows that the ice drill can include a cutting disk 210. The cutting disk 210 creates an attachment point for the cutting blade 205 and helps to remove the ice that has been cut by the cutting blade 205. I.e., the cutting disk is mounted on a central shaft and rotated, which creates proper motion of the cutting blade 205. As the ice is cut by the cutting blade 205, the cut ice slides up the cutting blade 205 onto the cutting disk 210.

### III. RECIPROCATING ENGINE

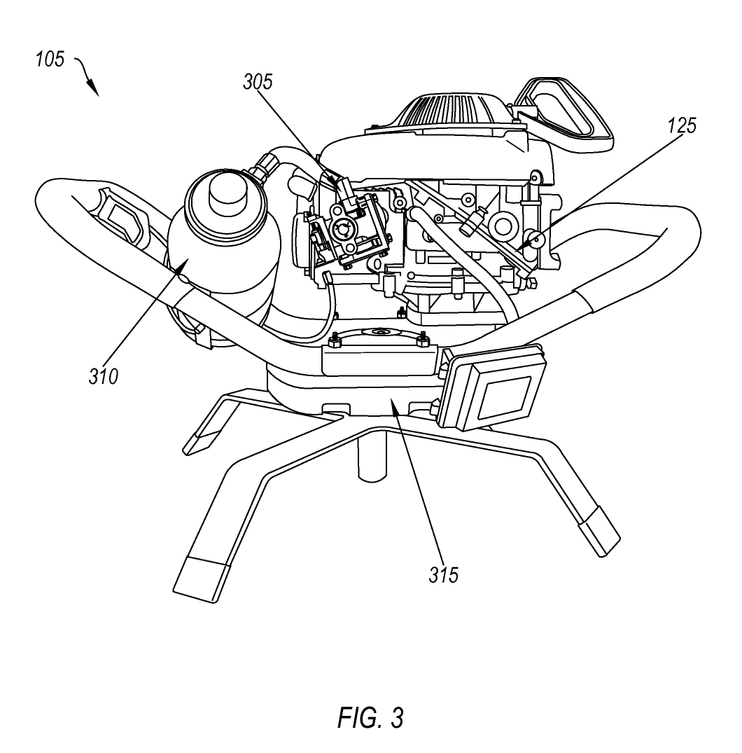

FIG. 3 illustrates an example of a power head 105. The power head is configured to allow the user to control operation of the ice drill. In particular, the user's hands will be on or near the drill power head 105, allowing the user to determine where the hole will be created and various factors of ice frill use, such as drill speed.

FIG. 3 shows that the power head 105 includes a propane carburetor 305. The propane carburetor 305 is a device that blends air and fuel for the engine 120. The propane carburetor 305 works on Bernoulli's principle: the faster air moves, the lower its static pressure, and the higher its dynamic pressure. I.e., the throttle (accelerator) linkage does not directly control the flow of liquid fuel. Instead, it actuates carburetor mechanisms which meter the flow of air being pulled into the engine 120. The speed of this flow, and therefore its pressure, determines the amount of fuel drawn into the airstream, as described below.

FIG. 3 also shows that the power head 105 includes a propane fuel source 310. The propane fuel source 310 includes any device which can provide propane to the engine 120. For example, the propane fuel source 310 can include a canister or other container which holds the propane fuel. Additionally or alternatively, the propane fuel source 310 can include a regulator or other device which controls the pressure or amount of propane available to the engine 120.

FIG. 3 further shows that the power head 105 can include a transmission 315. The transmission 315 includes an assembly of parts including the speed-changing gears and the propeller shaft by which the power is transmitted from an engine to a live axle. For example, in FIG. 1 the axle, via the transmission 315, creates rotation of the cutting head 110 and the auger 115. By convention, in an ice drill the transmission 315 creates left-hand rotation (counter clock-wise when viewing from above) rather than the right-hand rotation of most non-ice drill transmissions.

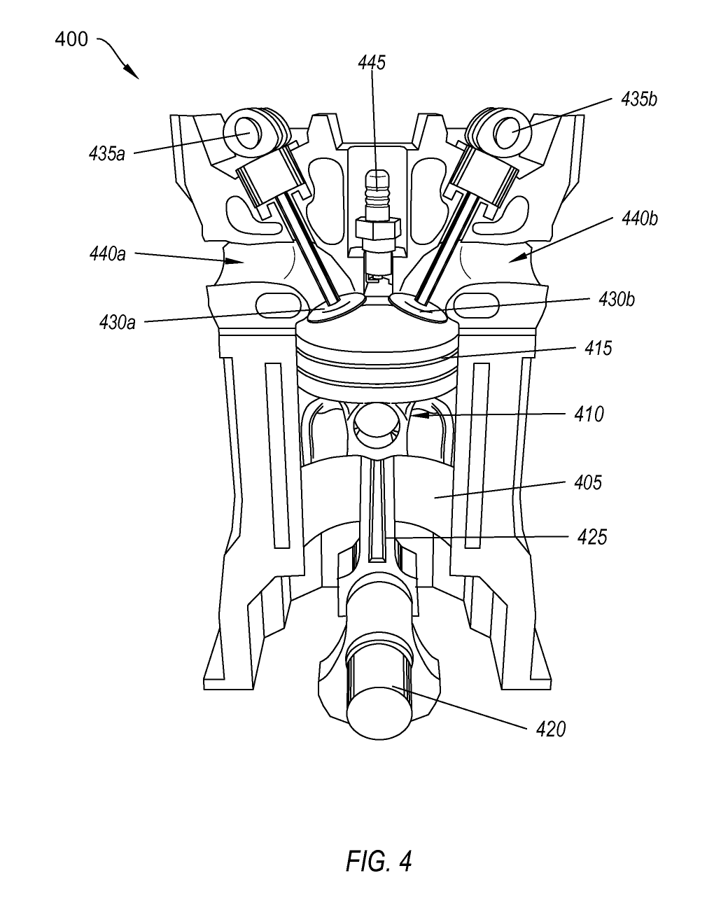

FIG. 4 illustrates an example of a reciprocating engine 400. In particular, a reciprocating engine 400 is a heat engine that converts pressure, from burning fuel or other sources, into a rotating motion used to produce work. Reciprocating engines 300 can include the internal combustion engine, the steam engine or a Stirling engine. One of skill in the art will appreciate that devices other than the reciprocating engine 400 can make use of implementations of the invention and that the reciprocating engine 400 is treated as exemplary, and not limiting, herein unless otherwise specified in the claims.

FIG. 4 shows that the reciprocating engine 400 can include a cylinder 405. The cylinder 405 is a chamber into which a gas is introduced, either already hot and under pressure (e.g., in a steam engine), or heated inside the cylinder 405 either by ignition of a fuel air mixture (e.g., in an internal combustion engine) or by contact with a hot heat exchanger in the cylinder 405 (e.g., in a Stirling engine). The hot gases can expand within the cylinder 405, with the energy of expansion converted into work, as described below.

FIG. 4 also shows that the reciprocating engine 400 can include a piston 410. The piston 410 can includes a solid piece of material tightly fitting and moving within the cylinder 405. The piston 410 can convert the energy produced by the gas expanding within the cylinder 405 into linear motion, which can be used to perform work, as described below. One of skill in the art will appreciate that in other applications, the function of the piston 410 can be reversed and force can be imparted to the piston 410 for the purpose of compressing or ejecting the fluid in the cylinder 405. Additionally or alternatively, the piston 410 also acts as a valve by covering and uncovering ports in the cylinder 405 wall.

One of skill in the art will appreciate that the reciprocating engine 400 can include more than one cylinder 405, each of which contains a piston 410. In general, the more cylinders 405 a reciprocating engine has, the more vibration-free (smoothly) it can operate. The power of a reciprocating engine can be proportional to the volume of the combined displacement of the pistons 410. In some implementations, the piston 410 may be powered in both directions in the cylinder 405 in which case it is said to be double acting. In the reciprocating engine 400 the cylinders 405 may be aligned in line, in a V configuration, horizontally opposite each other, or radially. Opposed-piston 410 engines can put two pistons 410 working at opposite ends of the same cylinder 405 and this has been extended into triangular arrangements such as the Napier Deltic.

It is common for such reciprocating engines 400 to be classified by the number and alignment of cylinders and the total volume of displacement of gas by the pistons 410 moving in the cylinders usually measured in cubic centimeters (cm³ or cc) or liters (l or L). For example, for internal combustion engines, single and two-cylinder designs are common in smaller vehicles such as motorcycles, while automobiles typically have between four and eight cylinders, and locomotives, and ships may have a dozen cylinders or more. Cylinder 405 capacities may range from 10 cm³ or less in model engines up to several thousand cubic centimeters in a ship's engines.

FIG. 4 further shows that the reciprocating engine 400 can include one or more piston rings 415. The piston rings 415 can provide an airtight seal between the sliding piston 410 and the walls of the cylinder 405 so that the high pressure gas above the piston 410 does not leak past it and reduce the efficiency of the reciprocating engine 400. I.e., a better seal between the piston rings 415 and the cylinder 405 can equal higher engine output with reduced emissions and increase engine longevity due to reduced wear and reduced engine lubrication contamination. However, minor distortions in the piston can have a large effect on the seal between the piston rings 415 and the cylinder 405. The piston rings 415 can include hard metal rings which are sprung into a circular groove in the head of piston 410.

FIG. 4 additionally shows that the reciprocating engine 400 can include a crankshaft 420. The crankshaft 420, sometimes abbreviated to crank, is the part of an engine which translates reciprocating linear motion of the piston 410 into rotation. I.e., the linear back-and-forth motion of the piston 410 is converted into rotation of the crankshaft 420. The crankshaft 420 can be connected to a flywheel, to reduce the pulsation characteristic piston 410 movement, and sometimes a torsional or vibrational damper at the opposite end, to reduce the torsion vibrations often caused along the length of the crankshaft by the cylinders farthest from the output end acting on the torsional elasticity of the metal.

FIG. 4 also shows that the reciprocating engine 400 can include a connecting rod 425. The connecting rod 425 can connect the piston 410 to the crankshaft 420. For example, it can impart the linear force of the piston 410 to the crankshaft 420. Additionally or alternatively, the connecting rod 425 can convert rotating motion from the crankshaft 420 into linear motion of the piston 410. To convert the reciprocating motion into rotation, the crankshaft 420 can include crank throws, also called crankpins, or other bearing surfaces whose axis is offset from that of the crankshaft 420 and to which the connecting rod 425 can be connected. In at least one implementation, the connecting rod 425 can be rigid in order to transmit either a push or a pull from the piston 410 and so the connecting rod 425 can rotate the crankshaft 420 through both halves of a revolution.

FIG. 4 further shows that the reciprocating engine 400 can include a first valve 430a and a second valve 430b (collectively “valves 430”). The valves 430 can control the flow of gases into or out of the cylinder 405. In particular, the valves 430 can be biased into the open position using a spring or some other mechanism and can be closed when necessary.

FIG. 4 additionally shows that reciprocating engine 400 can include a first camshaft 435a and a second camshaft 435b (collectively “camshafts 435”). The camshaft 435 can include a shaft which includes a disk or cylinder having an irregular form such that its motion, usually rotary, gives to a part or parts in contact with it a specific rocking or reciprocating motion. In particular, the first camshaft 435a and the second camshaft 435b can rotate, providing regular intervals at which the first valves 430a and the second valve 430b respectively, are opened and closed.

FIG. 4 also shows that the reciprocating engine 400 can include an intake port 440a and an exhaust port 440b (collectively “ports 440”). The intake port 440a can be used to allow fuel, air or a fuel/air mixture into the cylinder 405, where it will expand to drive the piston 410 and the exhaust port 440b can allow waste gases to exit the cylinder 405.

FIG. 4 further shows that the reciprocating engine 400 can include a spark plug 445. A spark plug 445 is an electrical device that fits into the cylinder 405 and ignites the fuel/air mixture by means of an electric spark. In particular, the spark plug 445 can include an insulated central electrode which is connected by a heavily insulated wire to an ignition coil or magneto circuit on the outside, forming, with a grounded terminal on the base of the plug, a spark gap inside the cylinder 405.

By way of example to show the operation of the reciprocating engine 400, in a 4-stroke engine, the first camshaft 435a can open the first valve 430a when the piston 410 is near the top of the cylinder 405. As the piston 410 moves toward the bottom of the cylinder 405 the movement can “pull” a fuel/air mixture into the cylinder 405. The first valve 430a can be closed and as the piston 410a moves toward the top of the cylinder 405, the fuel/air mixture is compressed. The sparkplug 445 can then be used to ignite to fuel/air mixture. The resulting expansion can drive the piston 410 toward the bottom of the cylinder 405. The second cam shaft 435a can then open the second valve 430a and as the piston 410 moves toward the top of the cylinder 405 the exhaust gases can be pushed out of the cylinder 405 and the cycle can begin again.

### IV. PROPANE CARBURETOR

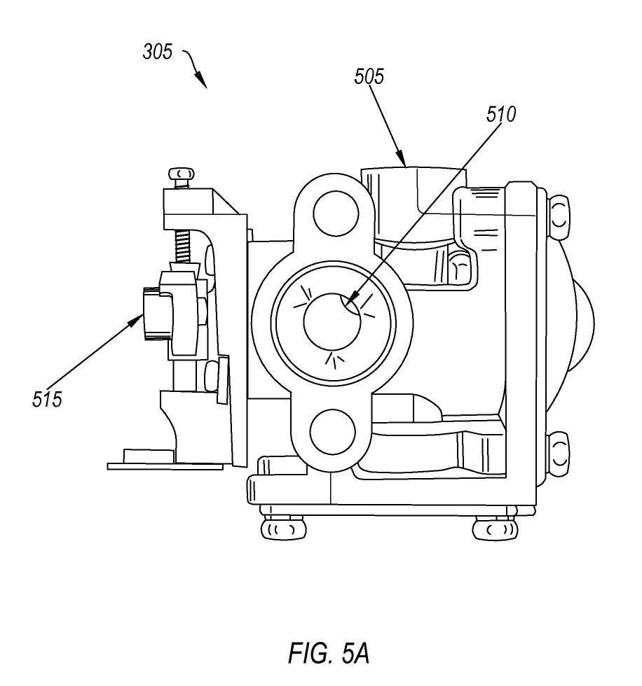

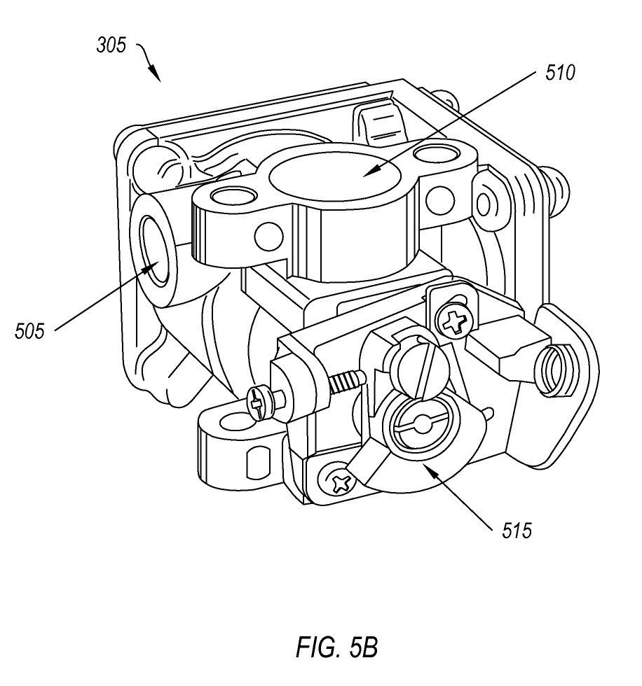

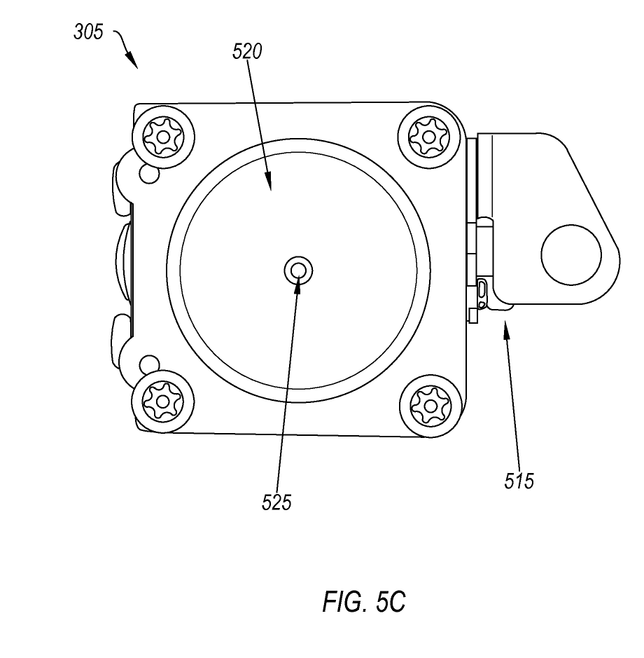

FIGS. 5A, 5B and 5C illustrate an example of a propane carburetor 305. FIG. 5A illustrates a side view of the propane carburetor 305; and FIG. 5B illustrates a perspective view of the propane carburetor 305; and FIG. 5C illustrates an alternative side view of the propane carburetor 305. In at least one implementation, the propane carburetor 305 (also carburettor or carburetter) is a device that blends air and propane for an internal combustion engine. In particular, the propane carburetor 305 mixes propane and air in a predetermined ratio and allows the mixture to flow into an internal combustion engine where it can be converted into mechanical energy. One of skill in the art will appreciate that although propane is treated as exemplary herein, the propane carburetor and any other parts in the specification and the claims can be used with other fuel types, such as other volatile hydrocarbons, unless otherwise specified.

In at least one implementation, propane can offer a number of benefits over other fuels. In particular, the engine can be started without priming, choking or the risk of flooding. Additionally or alternatively, propane has a wide operating range. In particular, propane remains an effective fuel between temperatures of −25 degrees Celsius or lower and 35 degrees Celsius. Further, propane produces fewer emissions than other fuels and does not leave contaminants if spilled.

FIGS. 5A, 5B and 5C show that the propane carburetor 305 can include a propane intake 505. In at least one implementation, the propane intake 505 allows propane to enter the propane carburetor 305. The propane will enter a mixing chamber within the propane carburetor 305. The flow of propane does not need to be forced or pumped, as the flow of air in the mixing chamber and the vapor pressure of the propane will create a pressure gradient which causes the correct amount of propane into the mixing chamber, as discussed below.

FIGS. 5A, 5B and 5C also show that the propane carburetor 305 can include an air intake 510. In at least one implementation, the air intake 510 allows air to enter the propane carburetor 305. One of skill in the art will appreciate that air can refer to any gas mixture which, when mixed with the propane, will allow the propane to undergo combustion. For example, the air can include air from the atmosphere of some other gas which includes oxygen for propane combustion.

In at least one implementation, the propane carburetor 305 can include an outlet. The outlet can allow the mixed propane and air to exit the mixing chamber. I.e., the outlet provides the propane and air mixture to the combustion chamber in an engine, where a spark is introduced and the propane is combusted and mechanical energy is produced. In particular, the outlet can be connected to the mixing chamber and the combustion chamber, such that the propane and air mixture can be drawn into the combustion chamber as needed for the engine to produce the required power.

FIGS. 5A, 5B and 5C further show that the propane carburetor 305 can include a disk actuator 515. In at least one implementation, the disk actuator 515 can control the flow of propane and air into the mixing chamber. In particular, the disk actuator 515 can control the air flow into the mixing chamber which, in turn, controls the propane flow into the mixing chamber, as described below. I.e. the disk actuator 515 can be connected to the throttle or throttle cable, allowing the operator to control the power output of the engine.

FIGS. 5A, 5B and 5C additionally show that the propane carburetor 305 can include cover 520. The cover 520 allows the diaphragm and valves below the cover to remain sealed. I.e., the cover 520 holds the necessary parts under the cover in the correct place during operation.

FIGS. 5A, 5B and 5C moreover show that the propane carburetor 305 can include an aperture 525 in the cover 520. The aperture 525 allows outside air to pass through the cover 520. I.e., air can freely flow through the aperture 525 such that the air pressure on both sides of the cover 520 remains equal at all times. That is, the air pressure just below the cover 520 is the ambient air pressure regardless of what the actual value of the ambient pressure.

FIG. 6 illustrates a cut away view of the propane carburetor 305. The cut-away view can be used to illustrate the propane flow through the propane carburetor 305. The propane carburetor 305 can be used to mix propane and air to be supplied to the combustion chamber, as described above. In particular, the propane carburetor 305 can be configured to work effectively with propane, a fuel that most carburetors are unsuitable for mixing in the proper ratio with air.

FIG. 6 shows that the propane carburetor 305 can include a passage 605. In at least one implementation, propane can enter the propane carburetor 305 through the passage 605. The flow rate of propane through the passage 605 can be controlled by the flow of air through the propane carburetor 305, as described below. Additionally, a needle valve can be used to control the amount of propane flowing through the passage 605, as described below. I.e., the propane can be pulled through the passage 605 at a variable rate which depends on the air flow and the position of a needle valve which provides the proper propane to air ratio based on its position and the position of the throttle.

FIG. 6 also shows that the propane carburetor 305 can include a venturi 610. In at least one implementation, the venturi 610 includes a constricted section of a pipe, shaft or other system through which a fluid, such as a liquid or gas, is flowing. The constriction results in a reduction in fluid pressure. According to the laws governing fluid dynamics, a fluid's velocity must increase as it passes through a constriction to satisfy the conservation of mass, while its pressure must decrease to satisfy the conservation of energy. Thus any gain in kinetic energy a fluid may accrue due to its increased velocity through a constriction is negated by a drop in pressure. This reduction in pressure in the venturi 610 pulls the propane through the passage 605 in the required amounts.

FIG. 6 further shows that the passage 605 and the venturi 610 can meet to form a mixing chamber 615. In at least one implementation, the pressure of the air entering the mixing chamber 615 through the venturi 610 is lower than ambient pressure. I.e., the air that enters the air intake is at ambient pressure, as the air passes through the venturi 610 the flow rate of the air is increased, but the pressure of the air is decreased. This decrease in air pressure results in a pressure imbalance within the passage 605. I.e., the propane intake pressure is higher than the pressure of the mixing chamber 615. This pressure imbalance forces the propane through the passage 605 into the mixing chamber 615.

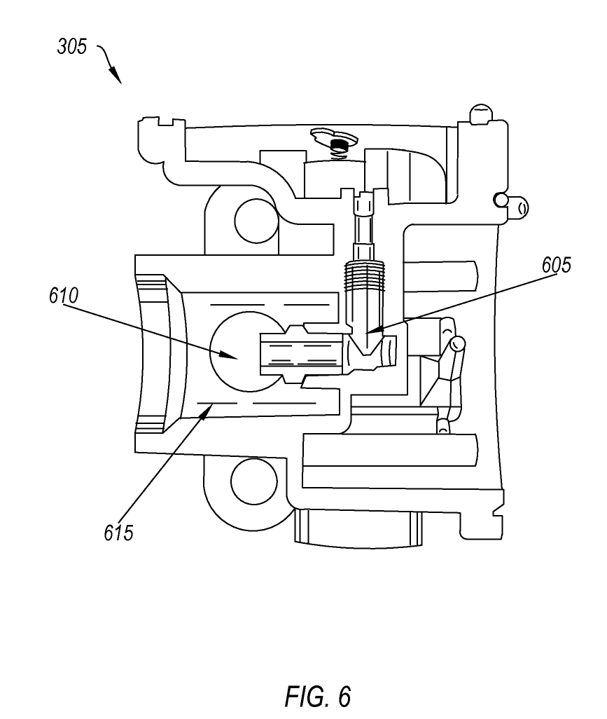

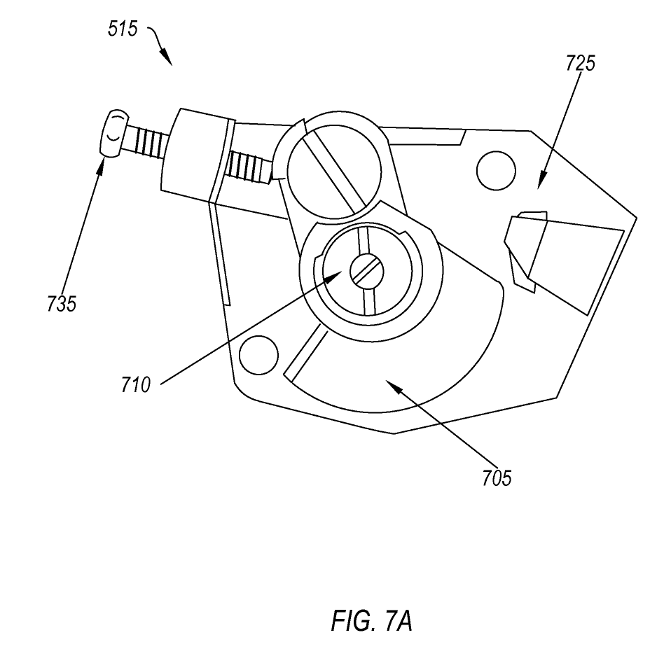

FIGS. 7A and 7B illustrate an example of a disk actuator 515 in idle position. FIG. 7A illustrates a side view of the disk actuator 515; and FIG. 7B illustrates a perspective view of the disk actuator 515. In at least one implementation, the disk actuator 515 is configured to control the flow of air and propane entering a propane carburetor, as described above. In particular, the disk actuator can be connected to a throttle controlled by an operator. The throttle can allow the operator to control the amount of propane and air entering a propane carburetor, which, in turn, controls the amount of power produced by the engine.

FIGS. 7A and 7B show that the disk actuator 515 can include a disk 705. One of skill in the art will appreciate that the disk need not be circular in shape. I.e., the disk 705 can include a disk or cylinder having an irregular form. That is, disk 705 can be shaped such that the diameter varies in different directions from the center of the disk 705. The varying diameter can allow for a nonrotational force to be applied to a particular portion of the disk 705 to be translated to rotational force. I.e., the disk 705 can include a portion that can translate linear motion over a short range into rotational motion.

FIGS. 7A and 7B also show that the disk actuator 515 can include a shaft 710. In at least one implementation, the disk 705 is attached to the shaft 710. Attaching the disk 705 to the shaft 710 can allow the rotational motion induced in the disk 705 to be transferred to the shaft 710. That is, if force is applied to the disk 705, the force is translated into rotational force of the disk 705, which, in turn, rotates the shaft 710. Rotation of the shaft 710 can allow more air to enter the propane carburetor, as described below. In particular, the rotation of the shaft 710 can transfer the force to the interior mechanisms of the disk actuator 515.

FIGS. 7A and 7B further show that the disk actuator 515 can include a plug 715. In at least one implementation, the plug 715 is configured to reside in a mixing chamber of a propane carburetor, such as the mixing chamber 615 shown if FIG. 6. The plug 715 can control the air flow through the mixing chamber which, in turn, can control the flow rate of the propane into the mixing chamber, as described above. For example, the plug 715 can rotate within the mixing chamber, allowing more or less air and propane to enter the mixing chamber, as desired by the operator.

FIGS. 7A and 7B show that the plug 715 can include a channel 720. In at least one implementation, the channel 720 can be aligned with the air intake and outlet of a propane carburetor, such as the air intake 510 and the outlet of FIGS. 5A, 5B and 5C. The amount of alignment can be used to control the air flow. In particular, if the channel 720 is not aligned with the air intake, no air can flow into the mixing chamber and the engine is, therefore, inoperable. However, if the channel 720 is aligned with the air intake to a low degree, only a small amount of air and propane can flow into the mixing chamber and the engine will produce little power. For example, the engine may be idling or at a very low throttle position. In contrast, if the channel 720 is aligned to a high degree with the air intake, then a high amount of air and propane will flow into the mixing chamber and the engine will produce a relatively higher amount of power.

One of skill in the art will appreciate that a force on the disk 705 can be used to align the channel 720 with the air intake. In particular, a throttle can be connected to the disk 705. Force on the throttle can be transferred to the disk 705 which will rotate the shaft 710. This will, in turn rotate the plug and adjust the alignment between the channel 720 with the air intake, which adjusts the amount of air and propane introduced into the combustion chamber. Thus, the operator can adjust the amount of power by adjusting the throttle.

FIGS. 7A and 7B further show that the disk actuator 515 can include a base 725. In at least one implementation, the base 725 can surround the shaft 710. The base 725 can include a guide 727 which is pushes the disk 705 away from the base 725 when the disk 705 is rotated, as described below. Additionally or alternatively, the base 725 can include a projection and the plug 715 can be mounted on the projection of the base 725. The interface between the plug 715 and the base 725 can include a threading. The threading can include a helical structure used to convert between rotational and linear movement or force. The conversion of force by the threading can bias the engine toward an idling position, as described below.

FIGS. 7A and 7B further show that the disk actuator 520 can include a compressed spring 730. In at least one implementation, the compressed spring 730 is configured to push the plug 715 away from the base 725 along the shaft 710. That is, unless there is a force which overcomes the force provided by the compressed spring 730, the compressed spring 730 will push the plug 715 away from the base 725 until rotational or linear motion of the plug 715 is prevented. For example, the movement of the plug 715 away from the base 725 can be prevented by the guide 727 or by a threaded interface between the plug 715 and the base 725. Thus, the spring 730 biases the channel 720 in a particular alignment relative to the air intake.

FIGS. 7A and 7B also show that the disk actuator 515 can include an idle screw 735. In at least one implementation, the idle screw 735 can allow a small amount of air and propane to enter the mixing chamber. In particular, the idle screw 735 prevents the disk 705 from rotating counter-clockwise, as shown in FIG. 7A, keeping a low level of alignment between the channel 720 and the air intake. This allows a small amount of air and propane to continue to enter the mixing chamber and pass into the combustion chamber.

In at least one implementation, the idle screw 735 can be configured to adjust the base alignment of the channel 720 relative to the air intake. In particular, as the idle screw 735 is screwed in, the alignment between the channel 720 and the air intake can be increase. Thus, the amount of air and propane entering the mixing chamber, and therefore the combustion chamber, is increased. In contrast, as the idle screw 735 is screwed out, the alignment between the channel 720 and the air intake can be decreased. Thus, the amount of air and propane entering the mixing chamber, and therefore the combustion chamber, is decreased.

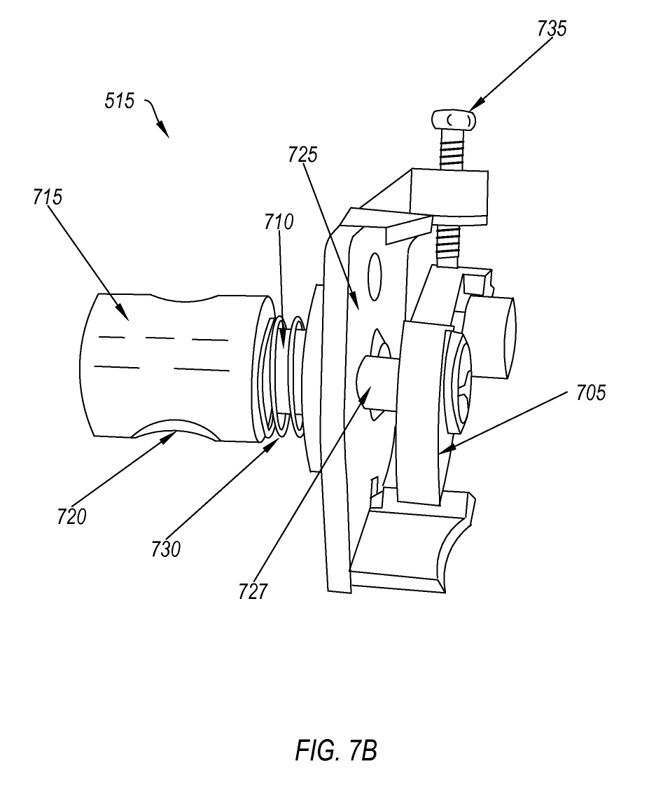

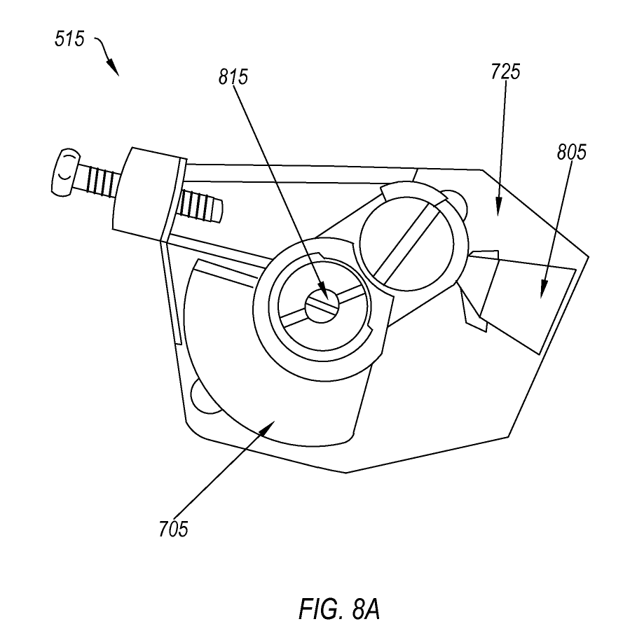

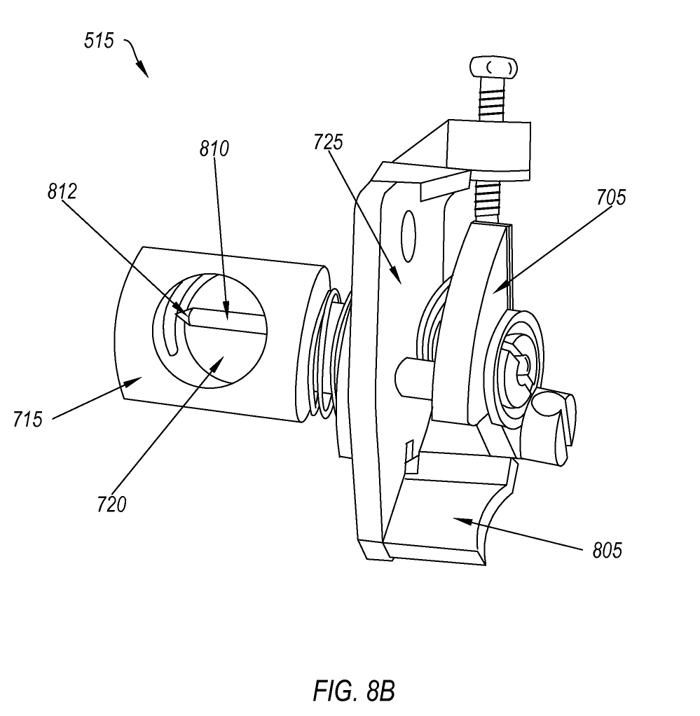

FIGS. 8A and 8B illustrate and example of a disk actuator 515 at full throttle. FIG. 8A illustrates a side view of the disk actuator 515; and FIG. 8B illustrates a perspective view of the disk actuator 515. In at least one implementation, the disk actuator 515 at full throttle is configured to supply the maximum amount of air and propane to the engine. I.e., the disk actuator at full throttle allows the engine to produce the maximum amount of power.

FIGS. 8A and 8B show that the disk 705 is rotated relative to the position of the disk 705 as shown in FIGS. 7A and 7B. In at least one implementation, the throttle can be configured to position the disk in any position between the positions shown in FIGS. 7A and 7B and the positions shown in FIGS. 8A and 8B. Additionally or alternatively, the throttle can be configured to position the disk only in the position shown in FIGS. 8A and 8B when force is applied to the throttle. This rotation of the disk 705, in turn, changes the orientation and position of the plug 715 relative to the propane carburetor.

FIGS. 8A and 8B further show that the disk actuator 515 can include a stop 805. In at least one implementation, the stop 805 is configured to stop the disk 705 as it rotates clockwise, as shown in FIG. 8A. I.e., the disk 705 is not allowed to rotate completely about the shaft. As the disk 705 stops rotating the channel 720 and the air intake are fully aligned. That is, the maximum amount of air and propane enter the mixing chamber and, therefore, the combustion chamber, producing the maximum amount of power output from the engine.

FIGS. 8A and 8B also show that the disk actuator 515 can include a needle-shaped plunger 810. In at least one implementation, the needle-shaped plunger 810 works in conjunction with a valve seat to form a needle valve. In particular, the needle-shaped plunger 810 can include a tapered end 812 which can be inserted into the valve seat, such as the end of the passage 605 of FIG. 6, in order to form a needle valve which controls the amount of propane flowing into the mixing chamber. The distance between the needle-shaped plunger 810 and the valve seat can control the amount of propane flowing into the mixing chamber. I.e., adjusting the needle-shaped plunger 810 can adjust the propane to air ratio, as described below.

In at least one implementation, the rotation of the disk 705 adjusts the position of the needle-shaped plunger 810 relative to the valve seat. In particular, as the disk 705 is rotated toward the stop 805, the needle-shaped plunger 810 moves toward the base 725. This movement, in turn, further separates the needle-shaped plunger 810 and the valve seat, increasing the amount of propane entering the mixing chamber and, therefore, the combustion chamber.

FIGS. 8A and 8B further show that the needle-shaped plunger 810 includes a head 815. A screwdriver or other tool can be inserted into the head 815 in order to change the alignment of the needle-shaped plunger 810 relative to the valve seat. In particular, as the head 815 is turned counter-clockwise and the needle-shaped plunger 810 is retracted, the distance between the valve seat and the plunger is increased; however, the needle-shaped plunger 810 continues to impede the flow somewhat. Thus, as the head is further turned, the flow of propane increases. Since it can take many turns of the head 815 to retract the plunger, precise regulation of the flow rate is possible. In contrast, as the head 815 is turned clockwise the needle-shaped plunger 810 is moved toward the valve seat, and the flow of propane is reduced. One of skill in the art will understand that the threading of the needle-shaped plunger 810 can be left-handed rather than right-handed; therefore turning the head 815 counter-clockwise can impede the flow of propane while turning the head 815 clockwise can increase the flow rate of the propane.

### V. PLUNGER VALVE AND OPERATION

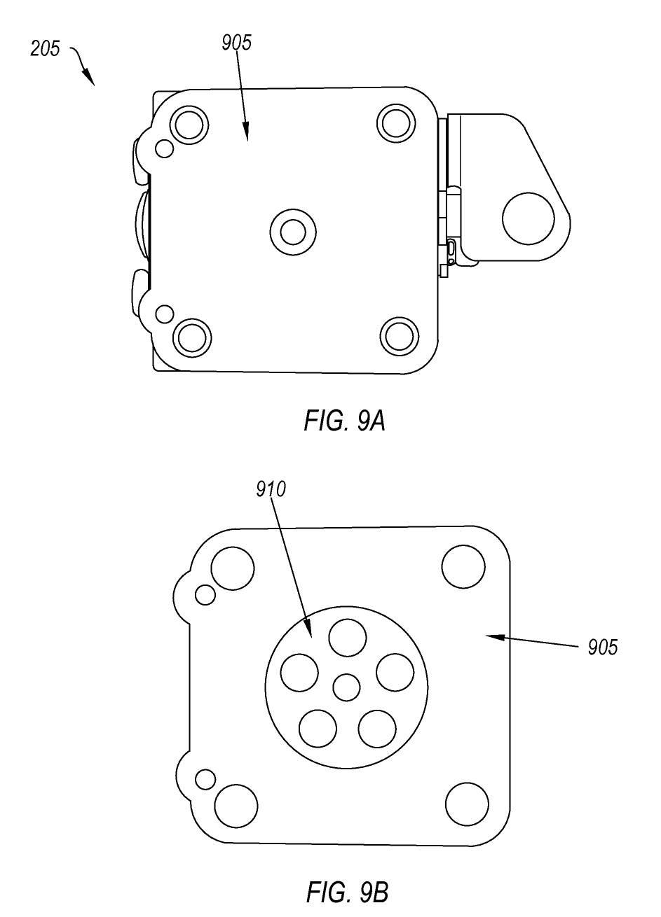

FIGS. 9A and 9B illustrate the propane carburetor 305 of FIG. 5C with the cover 520 removed. FIG. 9A illustrates a first side of the diaphragm 905 of the propane carburetor 305; and FIG. 9B illustrates the opposite side of the diaphragm 905 of the propane carburetor 305. FIGS. 9A and 9B show that the propane carburetor 305 can include a diaphragm 905. The diaphragm 905 includes a thin sheet of material forming a partition. In at least one implementation, the diaphragm 905 can separate chambers with different air pressures. For example, the outside of the diaphragm 905 can be in contact with the ambient air pressure that enters through the aperture 525 of FIG. 5C. In contrast, the inside of the diaphragm 905 can be in contact with the “internal” pressure of the propane carburetor 305. The internal pressure is dictated by the movement of the engine cylinder(s).

FIGS. 9A and 9B also show that the diaphragm 905 can include a disk 910. In at least one implementation, the disk 910 can be attached to the diaphragm 905. The disk 910 can provide rigidity to the desired portion of the diaphragm 905. Additionally or alternatively, the disk 910 can provide a surface that can interact with other portions of the diaphragm 905, as described below.

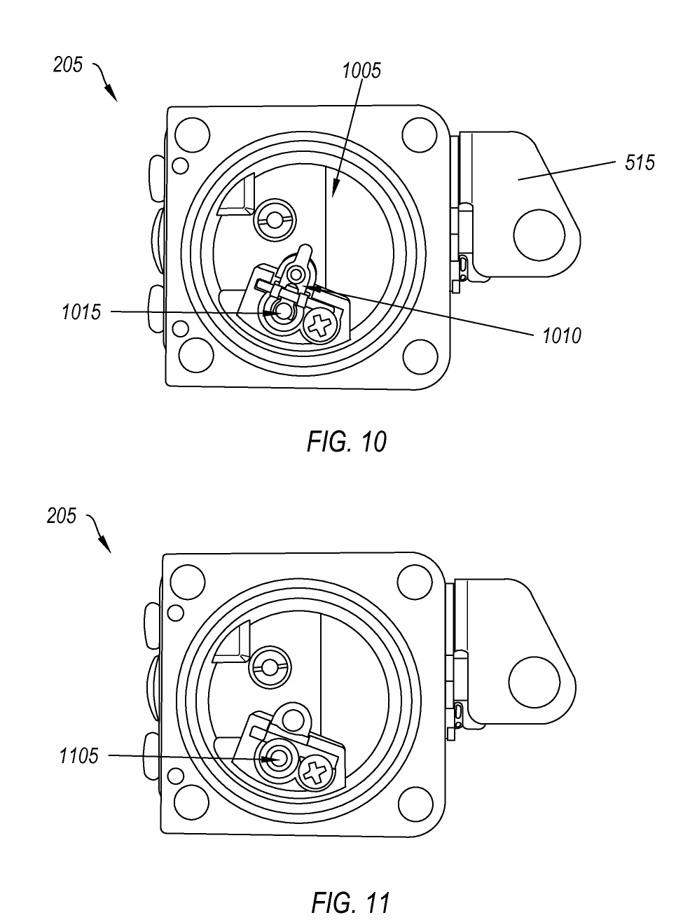

FIG. 10 illustrates the propane carburetor 305 of FIG. 9 with the diaphragm 905 removed. FIG. 10 shows that the propane carburetor 305 can include a fuel chamber 1005. The fuel chamber 1005 stores fuel that remains available for the engine. I.e., as the carburetor is required to provide a fuel-air mixture to an engine, the fuel is drawn from the fuel chamber 1005 down the passage 605 of FIG. 6. The propane carburetor 305 includes a disk actuator 515 including a needle-shaped plunger (as described in FIG. 8B).

FIG. 10 also shows that the propane carburetor 305 can also include a lever 1010. In at least one implementation, the lever 1010 can include a beam or rigid rod pivoted at a fixed hinge, or fulcrum. A first end of the lever 1010 (toward the middle of the mixing chamber 1005 as shown in FIG. 10) is biased upward by a spring (as can be seen in FIG. 6). As the diaphragm 905 of FIG. 9 moves inward under pressure the disk 910 of FIG. 9 is pressed against the first end of the lever 1010 causing it to move about the fulcrum.

FIG. 10 further shows that the propane carburetor 305 can include a plunger valve 1015. The plunger valve 1015 controls the flow of fuel into the fuel chamber 1005. In particular, as the first end of the lever 1010 is pressed downward, the other end rises opening the plunger valve 1015. While the plunger valve 1015 is open, the fuel flows past the plunger valve 1015, entering the fuel chamber 1005.

FIG. 11 illustrates the propane carburetor 305 of FIG. 10 with the plunger valve 1015 removed. FIG. 11 shows that the propane carburetor 305 can include a seat 1105. The seat 1105 is configured to receive the plunger valve 1015. In prior configurations, the seat 1105 was a simple opening. I.e., the seat 1105 was flat with a hole in the middle. However, operation of the propane carburetor 305 is improved if the shape is changed to match the shape of the plunger valve 1015, as described below.

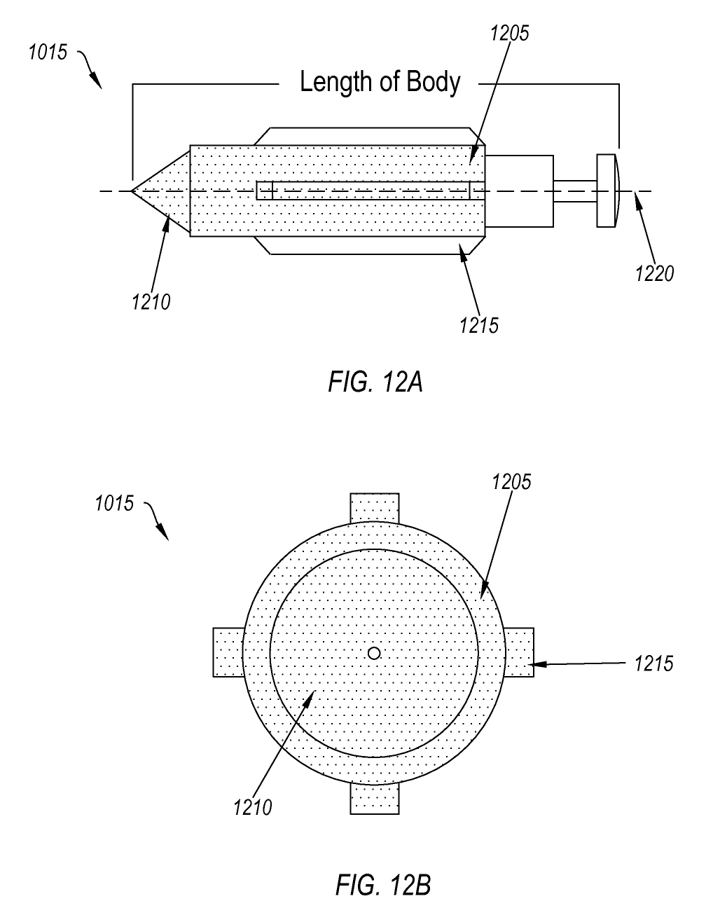

FIGS. 12A and 12B illustrate an example of a plunger valve 1015. FIG. 12A illustrates a side view of the plunger valve 1015; and FIG. 12B illustrates an end view of the plunger valve 1015. The size and the shape of the plunger valve 1015 can be critical for proper operation of the carburetor. For example, in a series of tests over 1000 carburetors in a prior configuration were tested for correct operation. The failure rate of the tests was over 300 carburetors (i.e., 30%) which malfunctioned at high rpms. In addition, problems could arise later during operation and appeared to be random failure.

Multiple testing and modification of parts did not result in satisfactory progress in preventing failures. After much experimentation it was discovered that the reduction in performance was the result of a flutter in the diaphragm 905 of FIG. 9. After extensive testing involving multiple changes to various portions of the carburetor including the diaphragm 905 of FIG. 9 changes were made to the plunger valve 1015 which reduced the failure rate to less than one percent. These changes reduced binding and made the movement of the plunger valve 1015 much smoother during operation. Accordingly, these changes are critical to proper operation of the carburetor.

FIGS. 12A and 12B show that the plunger valve 1015 can include a body 1205. The body 1205 can be the main portion of the plunger valve 1015. I.e., the body 1205 can include the central portion of the plunger valve 1015. The body 1205 can be long enough to allow for smoother operational action (less binding). For example, the body 1205 can be between 13 millimeters and 20 millimeters in length (as shown by the length indicator in FIGS. 12A and 12B). In particular, the body 1205 can be approximately 16.5 millimeters in length. As used in the specification and the claims, the term approximately shall mean that the value is within 10% of the stated value, unless otherwise specified.

FIGS. 12A and 12B also show that the plunger valve 1015 can include a conical shaped tip 1210. The conical tip 1210 can ensure that the pressure when seated with the valve seat remains uniform creating a better seal by the plunger valve 1015. I.e., the conical tip 1210 can seat uniformly, preventing any leakage and creating a more stable seal. The conical tip 1210 can be configured to seat in a complimentary shaped valve seat. I.e., the valve seat can likewise be conically shaped to match the shape of the conical tip 1210. Additionally or alternatively, the conical tip 1210 can include a material that is configured to provide a more secure seal. For example, the conical tip 1210 can include a soft deformable material such as latex.

FIGS. 12A and 12B further show that the plunger valve 1015 can include four or more flutes 1215. The four or more flutes 1215 can include ribs or longitudinal guides that are aligned longitudinally with the body 1205. The four or more flutes 1215 can be symmetrically spaced about the axis 1220 of the needle-shaped plunger. The flues 1215 can be critical to producing a smoother, more linearly-directed needle valve action. I.e., the flutes 1215 can eliminate valve binding during starting and running operations. During the previously described testing the plunger valve 1015 stuck and stuttered if fewer than four flutes 1215 (such as three flutes 1215) were used. However, with the addition of a fourth flute 1215 the wedging was eliminated and the movement of the plunger valve 1015 was smoother, eliminating failures. Additionally or alternatively, the flutes 1215 can be made wider to eliminate stutter. For example, the flutes 1215 can be up to 4 millimeters wide (as measured vertically in the flutes in the front and right/left FIGS. 12A and 12B respectively).

FIGS. 12A and 12B moreover show that the plunger valve 1015 can include a lubricant 1220 (one of skill in the art will appreciate that additionally or alternatively the lubricant 1220 can also be applied to the cylinder inner surface or in conjunction with both surfaces). The lubricant 1220 can prevent binding during starting and running operations, as described above. For example, the lubricant 1220 can include a solid or liquid lubricant. Dry lubricants or solid lubricants are materials which, despite being in the solid phase, are able to reduce friction between two surfaces sliding against each other without the need for a liquid medium. E.g., the lubricant 1220 can include the addition of a solid lubricant applied directly to the plunger valve using various processes in very thin nanometer layers. Examples of solid lubricants are: polytetrafluoroethylene (PTFE—most well-known by the DuPont brand name Teflon), molybdenum di-sulfide (MoS2), graphite (i.e., graphite impregnated in the surface), hexagonal boron nitride (aka “white graphite”), tungsten disulfide or other nanofilms commercially available. For example, one method to insure extended lubricity between plunger and cylinder could be to introduce surface porosity on the plunger flutes, then apply (infuse) the solid lubricant(s) onto, or within, the porous metal surface.

### VI. OPERATION OF A CARBURETOR

By way of example, operation of a carburetor will be described. I.e., the flow of fuel, air and fuel-air mixture will be described with respect to the carburetor as shown and described. To avoid confusion, reference numbers will be used herein which reflect the numbers previously assigned in the Figures and the specification. However, the Figures in which the reference numbers appear will be omitted.

Internal combustion engines operate on the inherent volume change accompanying oxidation of a fuel. The expansion moves a cylinder back and forth in a reciprocating motion. The reciprocating motion of the pistons is translated into crankshaft rotation via connecting rod(s). As a piston moves back and forth, a connecting rod changes its angle; its distal end has a rotating link to the crankshaft. A four stroke engine has four stages which includes two reciprocations of the cylinder (hence its name), each of which occurs during one revolution of the engine. The stages include:
1. INTAKE stroke: on the intake or induction stroke of the piston, the piston descends from the top of the cylinder to the bottom of the cylinder, increasing the volume of the cylinder. A fuel-air mixture is forced by atmospheric (or greater) pressure into the cylinder through the intake port. The intake valve(s) then closes.
2. COMPRESSION stroke: with both intake and exhaust valves closed, the piston returns to the top of the cylinder compressing the air or fuel-air mixture into the combustion chamber of the cylinder head. During the compression stroke the temperature of the air or fuel-air mixture rises by several hundred degrees.
3. POWER stroke: this is the start of the second revolution of the cycle. While the piston is close to the top of the cylinder, the compressed fuel-air mixture in a gasoline engine is ignited, usually by a spark plug. The resulting pressure from the combustion of the compressed fuel-air mixture forces the piston back down toward the bottom of the cylinder.
4. EXHAUST stroke: during the exhaust stroke, the piston once again returns to the top of the cylinder while the exhaust valve is open. This action expels the spent fuel-air mixture through the exhaust valve(s).

During the intake stroke the pressure in the combustion chamber is greatly reduced. Therefore, pressure in the mixing chamber causes the fuel-air mixture in the mixing chamber 615 to flow into the combustion chamber. That movement causes air to flow through venturi 610 and fuel to flow through passage 605 into the mixing chamber 615.

As fuel flows down passage 605 the pressure in the fuel chamber 1005 is reduced. The reduction in pressure causes the diaphragm 905 to move inward toward the fuel chamber 1005 under ambient pressure passing through the aperture 525 in the cover 520. The movement of the diaphragm 905, in turn, moves the disk 910 inward in the fuel chamber 1005 engaging the lever 1010. The plunger valve 1015 is then raised allowing fuel to enter the fuel chamber 1005. Because the fuel is pressurized the pressure in the fuel chamber 1005 quickly reaches ambient air pressure causing the diaphragm 905 to move back out of the fuel chamber 1005 disengaging the disk 910 from the lever 1010 and allowing the plunger valve 1015 to close, preventing fuel from entering the fuel chamber 1005.

Typical engine speeds can range from 3000 rpms (at idle speed) to 9000 rpms (at full throttle). Each revolution includes two strokes of the cylinder within the combustion chamber and two revolutions result in one draw of fuel-air mixture. Therefore, the plunger valve 1015 can reciprocate between 1500 times per minute (at idle speed) and 4500 times per minute (at full throttle) or between 25 times per second and 75 times per second. This means that the plunger valve has between approximately 0.013 seconds (at full throttle) and 0.040 seconds (at idle speed). Thus a delay of 1-2 thousandths of a second (0.001-0.002 seconds) caused by binding of the plunger valve 1015 can either flood (too much fuel) or stall (too little fuel) the engine. Therefore, the features and dimensions described above are critical to proper operation of the propane carburetor 305. I.e., even a small amount of binding can lead to failures in engine operation.

These failures are not applicable to engines that use other fuels, such as gasoline, which are a liquid at ambient temperatures. I.e., the fluid dynamics of a propane gas are different than the fluid dynamics of other fuels. Therefore, a shorter plunger valve 1015, fewer flutes 1215 and a hole in the seat 1105 rather than a conical shape might not cause problems in a gasoline carburetor but lead to failures in the operation of the propane carburetor 305.

### VII. CONCLUSION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An ice drill, the ice drill comprising:
a power head, the power head configured to allow the user to control operation of the ice drill;
an engine, the engine including:
a propane carburetor, the propane carburetor including:
a plunger valve, the plunger valve comprising:
a body;
a set of flutes on the body; and
a tip; and
a cutting blade, the cutting blade configured to be moved by the engine to create a hole in ice.

2. The ice drill of claim 1, wherein the set of flutes:
includes at least four flutes; and
are each symmetrically spaced about the axis of the body.

3. The ice drill of claim 1, wherein the length of the body is less than 20 millimeters.

4. The ice drill of claim 1:
further comprising a seat, wherein at least a portion of the seat is configured to receive the tip; and
wherein mating of the tip and seat forms a secure seal.

5. The ice drill of claim 4, wherein the portion of the seat configured to receive the tip is similar to the shape of the tip.

6. An ice drill, the ice drill comprising:
a power head, the power head configured to allow the user to control operation of the ice drill;
an engine, the engine including:
a propane carburetor, the propane carburetor including:
a plunger valve, the plunger valve comprising:
a body, configured to reduce wedging during operation and eliminate flutter when connected to a diaphragm, wherein the length of the body is between 13 millimeters and 20 millimeters;
a set of flutes on the body configured to reduce wedging during operation and eliminate flutter when connected to a diaphragm, wherein the set of flutes are each symmetrically spaced about the axis of the body; and
a tip; and
a cutting blade, the cutting blade configured to be moved by the engine to create a hole in ice.

7. The ice drill of claim 6, further comprising:
a lubricant on the body of the plunger valve.

8. The ice drill of claim 7, wherein the lubricant includes a solid lubricant.

9. The ice drill of claim 8, wherein the solid lubricant includes at least one of:
polytetrafluoroethylene;
molybdenum di-sulfide;
graphite;
hexagonal boron nitride; or
tungsten disulfide.

10. An ice drill, the ice drill comprising:
a power head, the power head configured to allow the user to control operation of the ice drill;
an engine, the engine including:
a propane carburetor, the propane carburetor including:
an air intake, wherein the air intake allows air to enter the propane carburetor;
a propane intake, wherein the propane intake:
allows propane to enter the propane carburetor; and
includes a plunger valve, wherein the plunger valve includes:
a body, wherein the length of the body is less than 20 millimeters;
a sold lubricant on the body of the plunger valve;
a set of flutes on the body configured to reduce wedging during operation and eliminate flutter when connected to a diaphragm, wherein the set of flutes are each symmetrically spaced about the axis of the body; and
a tip; and
a mixing chamber, wherein the propane entering the propane carburetor through the propane intake and the air entering the propane carburetor through the air intake are mixed in the mixing chamber; and
a cutting blade, the cutting blade configured to be moved by the engine to create a hole in ice.

11. The ice drill of claim 10 further comprising:
a disk actuator in the air intake, wherein the disk actuator includes:
a disk;
a plug, wherein the plug is connected to the disk such that rotation of the disk causes rotation of the plug and wherein the plug includes:
a channel, wherein the channel is configured to regulate the flow of air into the propane carburetor.

12. The ice drill of claim 11 further comprising a base, wherein the plug is capable of rotating relative to the base.

13. The ice drill of claim 12 further comprising a compressed spring wherein the compressed spring is configured to keep the plug in its furthest position from the base absent an external force.

14. The ice drill of claim 11 further comprising a needle valve, wherein the needle valve includes a needle-shaped plunger which regulates the flow of propane into a mixing chamber of the propane carburetor.

15. The ice drill of claim 14, wherein at least a portion the needle-shaped plunger is located within the plug.

16. The ice drill of claim 15, wherein the needle-shaped plunger includes an end configured to be inserted into a valve seat, wherein the valve seat is connected to the passage from the fuel chamber to the mixing chamber.

17. The ice drill of claim 10 further comprising:
a fuel chamber, wherein the fuel chamber is configured to store propane prior to mixing;
a diaphragm between the fuel chamber and an external environment;
a lever, wherein a first end of the lever is engaged by the diaphragm;
wherein the plunger is activated by a second end of the lever; and
a passage from the fuel chamber to the mixing chamber.

18. The ice drill of claim 17, wherein the diaphragm includes a disk, wherein the disk is configured to engage the first end of the lever.

19. The ice drill of claim 17 further comprising a spring, wherein the spring is:
in contact with the lever; and
configured to bias the lever to hold the plunger valve in a closed position.

20. The ice drill of claim 17 further comprising a cover over the diaphragm, wherein the diaphragm includes:
an aperture.
